(19) United States
(12) Patent Application Publication
(10) Pub. No.: US 2020/0146440 A1
(43) Pub. Date: May 14, 2020

(54) WORKSTATION CONTROLLER FOR A POWER-ACTUATED WORKSTATION

(71) Applicant: SPARX SMARTPODS INC., Moncton, New Brunswick (CA)

(72) Inventors: Tim Fogarty, Moncton, New Brunswick (CA); Leon DesRoches, Moncton, New Brunswick (CA)

(21) Appl. No.: 16/620,836

(22) PCT Filed: Jun. 8, 2018
(86) PCT No.: PCT/CA2018/050689

§ 371 Date: Dec. 9, 2019

Related U.S. Application Data
(60) Provisional application No. 62/517,643, filed on Jun. 9, 2017.

(51) Int. Cl. A47B 9/00; A47B 21/02; G05B 9/02; A47B 21/04

(52) U.S. Cl. CPC A47B 9/00; A47B 21/02; A47B 21/04; G05B 9/02; A47B 2200/0062; A47B 2200/0056

(57) ABSTRACT

A workstation controller includes a processor. A memory, a first drive control output, a first current sensor, and one or more user operable controls are each communicatively coupled to the processor. When the workstation controller is communicatively connected to a first drive controller that operates at least a first workstation actuator, the processor is configured to (i) receive, from the first current sensor, a first current reading of electrical current flowing from the first drive controller to the first workstation actuator, and (ii) in response to the processor determining that the first current reading exceeds a predetermined current threshold associated with obstructive interference, transmit to the first drive controller, by way of the drive control output, one or more commands to operate the first workstation actuator to perform a safety protocol stored in the memory.

This application claims the benefit of Provisional Application Ser. No. 62/517,643, filed Jun. 9, 2017, which is hereby incorporated herein by reference.

### FIELD

This application relates to the field of workstation controllers for power-actuated workstations.

### INTRODUCTION

A power actuated workstation may include one or more actuators, such as electric motors or solenoids, that drive one or more work surfaces (e.g. tabletop or keyboard tray) to move (e.g. linearly, rotationally, or arcuately) relative to one or more axes of the workstation. For example, a sit-stand desk may include one or more vertical columns that support a tabletop and that are power extensible to move the tabletop vertically between a seated height and a standing height.

### DRAWINGS

FIG. 1 is a bottom perspective view of a workstation, showing OEM user operable controls being replaced by a workstation controller, in accordance with an embodiment;

FIG. 2A is a side view of a workstation with a tabletop in a raised and rearward position;

FIG. 2B is a side view of the workstation of FIG. 2A, with the tabletop in a raised and forward position;

FIG. 3A is a side view of the workstation of FIG. 2A, with the tabletop in a lowered and rearward position;

FIG. 3B is a side view of the workstation of FIG. 2A, with the tabletop in a lowered and forward position;

FIG. 4 is a schematic illustration of a workstation controller communicatively coupled to drive controllers and drive actuators, and OEM user operable controls disconnected from the drive controllers;

FIG. 5 is a partial perspective view of a workstation with a workstation controller in accordance with an embodiment;

FIG. 6 is a partial perspective view showing a workstation controller being mounted to a workstation tabletop in accordance with an embodiment;

FIG. 7 is a rear view of a workstation controller in accordance with an embodiment;

FIG. 8A is a schematic illustration of a drive power module in accordance with an embodiment;

FIG. 8B is a schematic illustration of a drive power module in accordance with another embodiment;

FIG. 9 is a bottom perspective view of a workstation in accordance with another embodiment;

FIG. 10 is a flowchart illustrating a method of controlling a workstation in accordance with an embodiment;

FIG. 11 is a perspective view of a workstation controller in accordance with an embodiment;

FIG. 12 is a side view of the workstation controller of FIG. 11; and

FIG. 13 is a flowchart illustrating a method of controlling a workstation in accordance with an embodiment.

### SUMMARY

In a first aspect, a workstation controller is provided for operating at least one drive controller of a power actuated workstation, each drive controller operating at least one workstation actuator. The workstation controller may include one or more processors, a memory communicatively coupled to at least one of the processors and storing a safety protocol, a first drive control output communicatively coupled to at least one of the processors, a first current sensor communicatively coupled to at least one of the processors, and one or more user operable controls each communicatively coupled to at least one of the processors. When the workstation controller is communicatively connected to a first drive controller that operates at least a first workstation actuator, the one or more processors are configured to collectively: (a) determine one or more actuator movements for the first workstation actuator based at least in part on user-input received from the one or more user operable controls, (b) transmit to the first drive controller, by way of the first drive control output, one or more commands to operate the first workstation actuator to perform the one or more determined actuator movements, (c) receive, from the first current sensor, a first current reading of electrical current flowing from the first drive controller to the first workstation actuator, and (d) in response to the processor determining that the first current reading exceeds a predetermined current threshold associated with obstructive interference, transmit to the first drive controller, by way of the drive control output, one or more commands to operate the first workstation actuator to perform the safety protocol.

In another aspect, a workstation controller is provided for operating at least one drive controller of a power actuated workstation, each drive controller operating at least one workstation actuator. The workstation controller may include one or more processors, a memory communicatively coupled to at least one of the processors and storing a safety protocol and position criteria associated with obstructive interference, a first drive control output communicatively coupled to at least one of the processors, a position sensor communicatively coupled to at least one of the processors, and one or more user operable controls each communicatively coupled to at least one of the processors. When the workstation controller is communicatively connected to a first drive controller that operates at least a first workstation actuator, the one or more processors are configured to collectively: (a) determine one or more actuator movements for the first workstation actuator based at least in part on user-input received from the one or more user operable controls, (b) transmit to the first drive controller, by way of the first drive control output, one or more commands to operate the first workstation actuator to perform the one or more determined actuator movements, (c) receive, from the position sensor, a position reading associated with a workstation tabletop of the power actuated workstation, and (d) in response to determining that the position reading satisfies the position criteria, transmit to the first drive controller, by way of the drive control output, one or more commands to operate the first workstation actuator to perform the safety protocol.

In another aspect, a workstation controller is provided for operating at least one drive controller of a power actuated workstation, each drive controller operating at least one workstation actuator. The workstation controller may include one or more processors, a memory communicatively coupled to at least one of the processors and storing an automatic movement regimen, a first drive control output communicatively coupled to at least one of the processors, and one or more user operable controls each communicatively coupled to at least one of the processors. When the workstation controller is communicatively connected to a first drive controller that operates at least a first workstation actuator, the one or more processors are configured to collectively: (a) receive from the one or more user operable controls, user input indicative of a selection to operate in a semi-automatic mode of operation, (b) determine a plurality of actuator movements to perform in sequence based at least in part on the automatic movement regimen, and (c) transmit to the first drive controller, by way of the first drive control output, one or more commands to operate the first workstation actuator to perform the plurality of determined actuator movements; wherein before transmitting commands to perform each actuator movement of the plurality of actuator movements, the one or more processors are collectively configured to wait for user confirmation.

In another aspect, a method of upgrading a power operated workstation is provided. The method may include disconnecting OEM user operable controls from the power operated workstation, attaching any workstation controller disclosed herein to the power operated workstation, communicatively coupling the workstation controller to a first drive controller, and connecting a first current sensor to a power line that delivers power to a first workstation actuator.

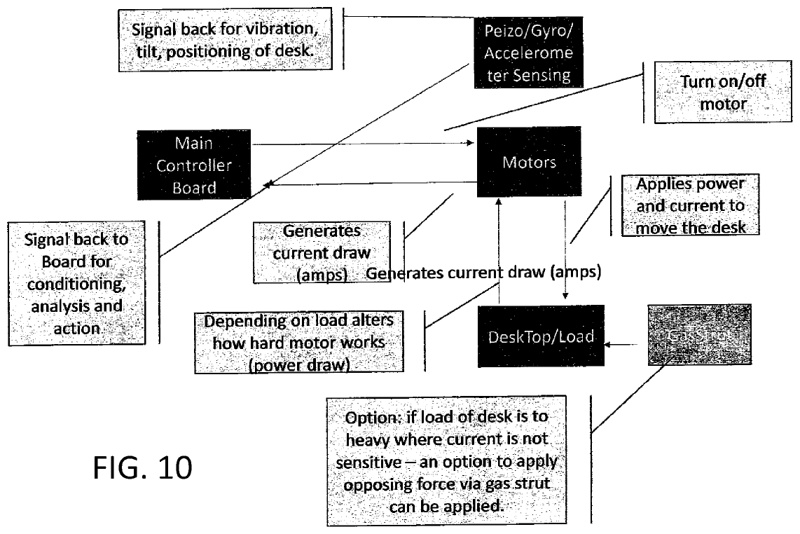

A workstation controller may have a built-in safety system that may measure, for example, current from the existing columns or structural features of a workstation. In some embodiments, the safety system may measure the tilt of the workstation controller when attached to the workstation via a tilt sensor, gyroscope, etc. In other embodiments, the built-in safety system may also connect to the workstation or other workstations, for example, for fixing or repairing the connected workstation. When automating a workstation, automatic safety may be provided through the sensors and current sensing within the control box. FIG. 10 further describes a method of adjusting the workstation based on various input gathered by the sensors (e.g., changes in current), to provide safety. For example, a gyroscope may measure various types of motion or tilt of the workstation controller (and consequently the workstation on which the workstation controller rests), and may activate the safety system based on the motion or tilt determined by the gyroscope. The workstation controller may have multiple sensors, including but not limited to sensors for temperature, light, sound, and motion, including infrared sensors.

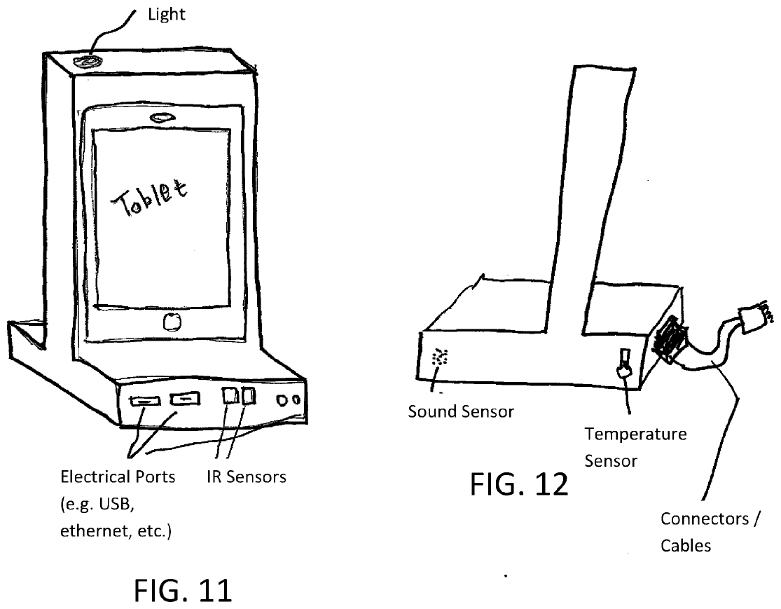

FIGS. 11 and 12 depict an exemplary workstation controller for a system and method for automating a workstation, according to an exemplary embodiment. Moreover, FIG. 11 and FIG. 12 may depict the workstation controller from a front perspective and side, respectively. As depicted in FIG. 11, the workstation controller may have a light, reading lens, or other accessory affixed to it, for the user's convenience. In an embodiment, the lens may sit on top of the light shown in FIG. 11. The workstation controller may further include an area for placing a tablet, smartphone, small computer, etc., that may run a software for automating a workstation and managing an interactive workstation. The software for the interactive workstation may be run according to systems and methods described in U.S. patent application Ser. No. 15/349,466, which is hereby incorporated by reference. As depicted in FIG. 11, the workstation controller may further include various electrical ports, e.g., for USB, Ethernet, display port, DVI, headphone jack, HDMI, etc., to enhance the user's experience of the automated workstation, or to connect to other sensors. The workstation controller, as depicted in FIGS. 11 and 12 may include various sensors, including, for example, an infrared sensor, a light sensor, and/or a temperature sensor. Furthermore, as depicted in FIG. 12, the workstation controller may have connectors or cables that connect to the control box of the workstation. In some embodiments, the control box may be a preexisting controller of an interactive workstation.

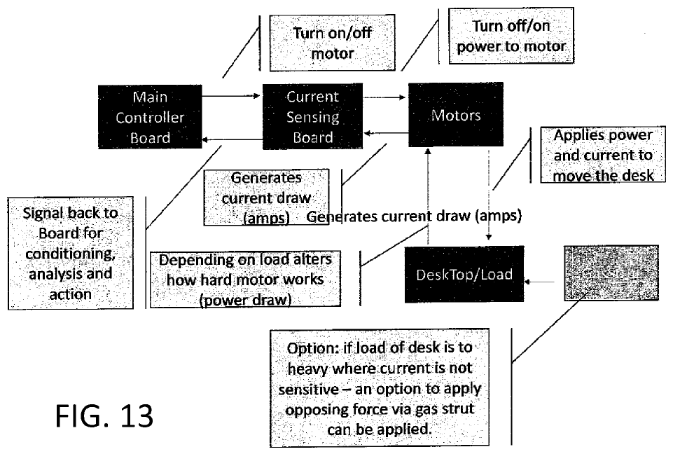

FIG. 13 depicts a flow chart of a process executed by the workstation controller for automating a workstation, in accordance with an exemplary embodiment. It is contemplated that the workstation controller may be used to automate a workstation (e.g., make the workstation “smart”), via sensing various features of the workstation (e.g., its current) and/or the environment in which the workstation controller and workstation are located. For example, as depicted in FIG. 13, to make the workstation “smart,” remote current sensing may be used. The workstation controller may include, for example, motor cables that may be connected to a remote board, which may intercept the current from the workstation and divert the current signals to the main control board of the workstation controller. The control board may process and/or condition the signal to remove unwanted spikes. Furthermore, the control board may average the signal while still keeping a high response time, and output a valid number. For example, the control board may average the signal enough to get a valid signal but not enough to slow the response. The valid number may then be compared during travel. In the first few seconds, the control board may gage the normal range. This normal range may then be compared to the range in the next cycle (e.g., in the next few seconds). If the range exceeds a custom or predefined tolerance, the workstation controller may program the workstation to perform an appropriate action, like reversing direction.

A maximum value may also be predefined for the current signal so that the current signal does not exceed the maximum value, e.g., to prevent heavy current spikes. In such embodiments, where there is a heavy current spike, the workstation controller may program the workstation to perform a motor binding or a hardstop.

In some workstations, the workstation controller may be programmed to detect a heavy table top load. Depending on the motor being connected to or monitored by the workstation controller, the workstation controller may activate an opposing force on the motor. In one embodiment, a gas strut may be applied to create the opposing force against the tabletop's motion so the motor, while moving downward, has to “work” or face more resistance. This mechanism may ensure that the system can react to a detectable current. If no gas strut is available, and there is a heavy load on the tabletop relative to the motor's capability, the weight of the load may need to be countered and/or overcome before there is a change or adjustment in the motor current. Moreover, the change in current may depend on the weight of the load of the tabletop, and the current may be adjusted to overcome the heavy weight before more load is applied to the tabletop, and before the heavier load causes the motor to increase its current usage. It is contemplated that for some workstations, depending on the power voltage, the load on the workstation may not need to trigger this mechanism, since the current sensitivity relative to the tabletop may be minor. These workstations may include, for example, smaller desks with two column motors on each end, and set at a lower voltage power source but at a higher current.

The system design may accommodate any power configuration to intercept the current draw in these scenarios. Once the current and configuration is determined, a gas strut may be added or activated.

FIG. 10 depicts a flow chart of a process executed by the workstation controller for ensuring the safety of the workstation, in accordance with an exemplary embodiment. For safety, the workstation controller may also take alternate sensors or signals. For example, the workstation controller may gage or adjust the position of the workstation from input gathered from a gyroscope and/or an accelerometer. These sensors, either in combination or individually, may be used to determine, for example, whether the desk is tilting and on which axis. The information may be presented on a user interface of the workstation controller. If the tilt exceeds tolerances, the workstation may take appropriate action, for example, by reversing motor direction. The signal gathered from the sensors may be processed according to similar steps as described in FIG. 13 (e.g., conditioning the signal, averaging the signal enough to get a valid signal but not enough to slow the response). Based on the inputs gathered from the processed signals, an appropriate action may be applied to ensure safety.

As depicted in FIG. 10, the workstation controller has alternate inputs to adapt sensors for safety within the desk. For example, a pressure sensor may gage whether a leg of a workstation has been lifted or is above an appropriate elevation relative to other legs. Input gathered from this pressure sensor, and the actions taken by the workstation controller to correct or fix the workstation may be similar to that performed for detecting tilt, as described above.

### DESCRIPTION OF VARIOUS EMBODIMENTS

Numerous embodiments are described in this application, and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with modification and alteration without departing from the teachings disclosed herein. Although particular features of the present invention may be described with reference to one or more particular embodiments or figures, it should be understood that such features are not limited to usage in the one or more particular embodiments or figures with reference to which they are described.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, “joined”, “affixed”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, “directly joined”, “directly affixed”, or “directly fastened” where the parts are connected in physical contact with each other. As used herein, two or more parts are said to be “rigidly coupled”, “rigidly connected”, “rigidly attached”, “rigidly joined”, “rigidly affixed”, or “rigidly fastened” where the parts are coupled so as to move as one while maintaining a constant orientation relative to each other. None of the terms “coupled”, “connected”, “attached”, “joined”, “affixed”, and “fastened” distinguish the manner in which two or more parts are joined together.

Further, although method steps may be described (in the disclosure and/or in the claims) in a sequential order, such methods may be configured to work in alternate orders. In other words, any sequence or order of steps that may be described does not necessarily indicate a requirement that the steps be performed in that order. The steps of methods described herein may be performed in any order that is practical. Further, some steps may be performed simultaneously.

As used herein and in the claims, a first element is said to be ‘communicatively coupled to’ or ‘communicatively connected to’ or ‘connected in communication with’ a second element where the first element is configured to send or receive electronic signals (e.g. data) to or from the second element, and the second element is configured to receive or send the electronic signals from or to the first element. The communication may be wired (e.g. the first and second elements are connected by one or more data cables), or wireless (e.g. at least one of the first and second elements has a wireless transmitter, and at least the other of the first and second elements has a wireless receiver). The electronic signals may be analog or digital. The communication may be one-way or two-way. In some cases, the communication may conform to one or more standard protocols (e.g. SPI, I²C, Bluetooth™, or IEEE™ 802.11).

As used herein and in the claims, a group of elements are said to ‘collectively’ perform an act where that act is performed by any one of the elements in the group, or performed cooperatively by two or more (or all) elements in the group.

Some elements herein may be identified by a part number, which is composed of a base number followed by an alphabetical or subscript-numerical suffix (e.g. 112a, or 112₁). Multiple elements herein may be identified by part numbers that share a base number in common and that differ by their suffixes (e.g. 112₁, 112₂, and 112₃). All elements with a common base number may be referred to collectively or generically using the base number without a suffix (e.g. 112).

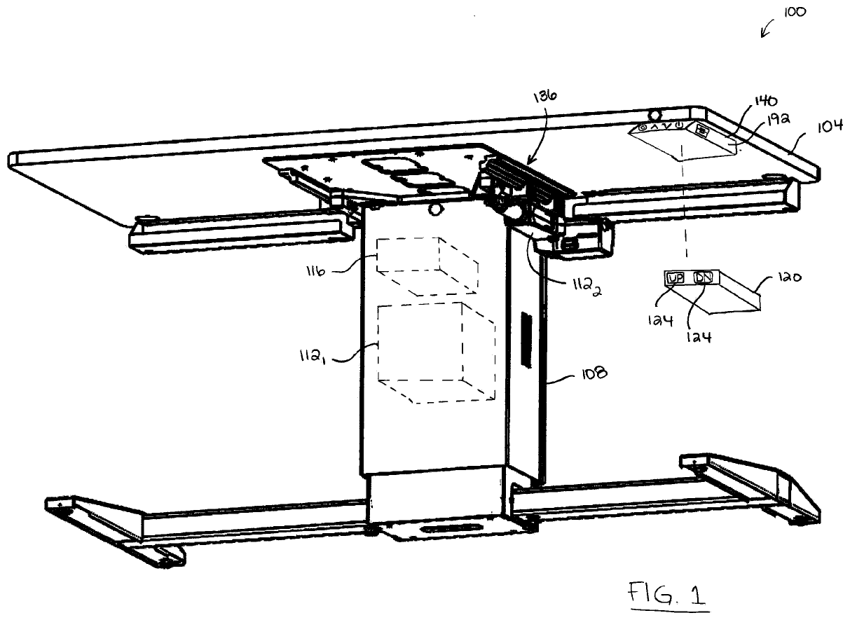

FIG. 1 shows a power-actuated workstation 100 in accordance with an embodiment. As shown, workstation 100 includes a tabletop 104 and a vertical support 108. Tabletop 104 may provide a user work surface, such as to support documents, a computer, computer monitor(s), or other user articles. Vertical support 108 may support tabletop 104 above the ground at an elevation which is convenient for the user to interact with the user articles on tabletop 104.

As used herein and in the claims, the “ground” is a common surface that supports the workstation and any users at the workstation. The ground may be an indoor or outdoor floor covering (e.g. hardwood flooring, tiles, carpet, concrete, patio stones, or gravel), or a natural uncovered surface (e.g. grass, or soil).

Workstation 100 may include one or more actuators 112 that are operable to move tabletop 104 (e.g. linearly, rotationally, or arcuately) relative to the ground. For example, workstation 100 may include a vertical actuator 112₁ that is operable to change the vertical position (i.e. elevation) of tabletop 104 above the ground, and a horizontal actuator 112₁ that is operable to change the horizontal position of tabletop 104 over the ground.

Actuator activation may be controlled by a drive controller 116. Drive controller 116 may activate actuators 112 (e.g. power the actuators 112 to execute a movement) in response to signals from user operable controls 120. For example, user operable controls 120 may include directional buttons 124 that a user can press to signal the drive controller 116 to activate the actuator(s) 112 responsible for moving tabletop 104 in the selected direction (e.g. up, down, in, or out).

An actuator 112 can be any device suitable to move tabletop 104 relative to the ground when activated by drive controller 116. An actuator 112 may include an electrically powered or electrically activated prime mover (i.e. source of motive power). For example, actuator 112 may include an electric motor (e.g. to drive a linear actuator, such as a leadscrew actuator), a solenoid (e.g. to provide linear motion directly, or to operate a valve), or a pump (e.g. to move fluid for activating a piston cylinder). Alternatively or in addition, an actuator 112 may be fluidly powered or fluidly activated. For example, actuator 112 may include a hydraulic or pneumatic device (e.g. a piston cylinder). Optionally, actuator 112 may include a mechanical transmission which may alter the directional characteristic of the prime mover (e.g. convert rotary to linear movement or vice versa), and/or provide mechanical advantage (e.g. multiply output force or torque). For example, actuator 112 may include one or more of gears, belts, screws, bar linkages, racks, or levers.

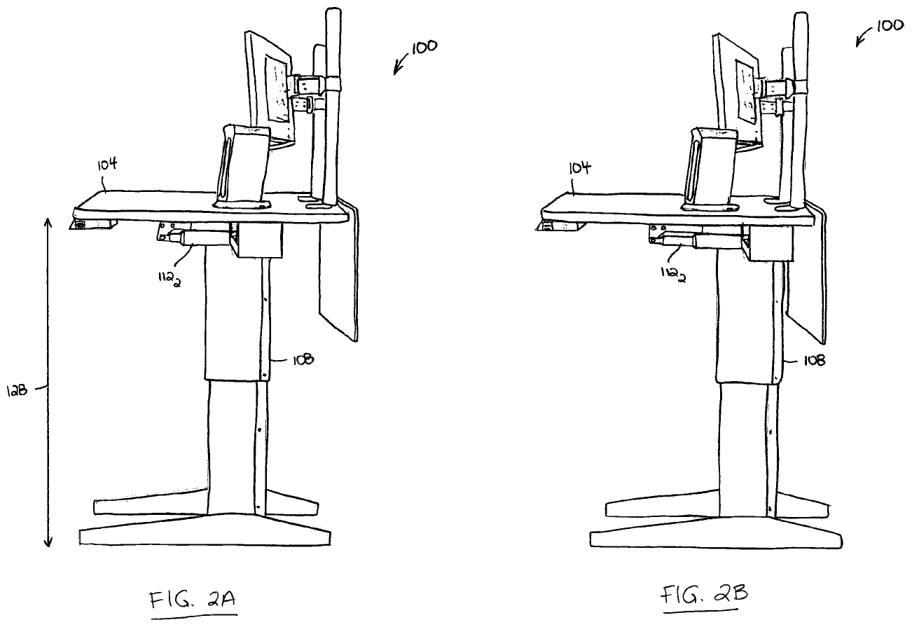

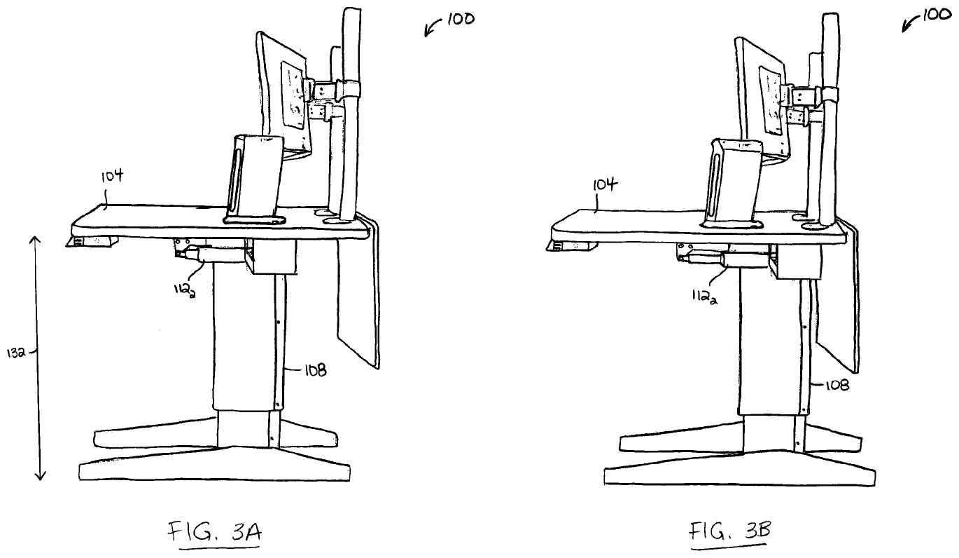

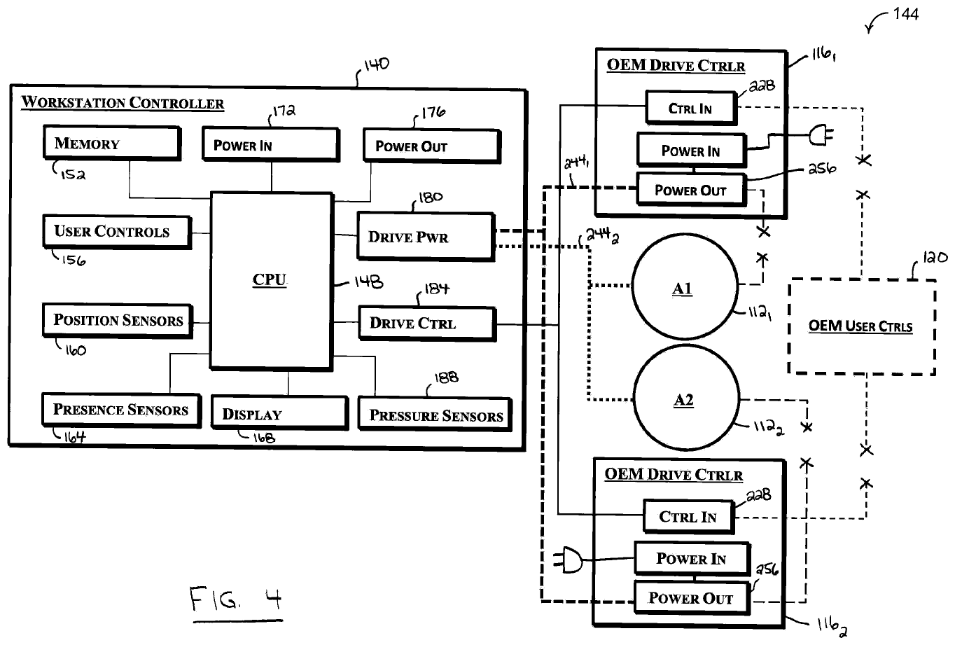

Reference is now made to FIGS. 2A-2B and 3A-3B, which show tabletop 104 moved to different positions by actuators 112 (FIG. 1). In the illustrated example, vertical actuator 112₁ (FIG. 1) is part of vertical support 108 and acts to extend and retract vertical support 108. For example, vertical actuator 112₁ may be operable to extend/retract vertical support 108 between a raised height (FIGS. 2A-2B, e.g. standing height) and a lowered height (FIGS. 3A-3B, e.g. sitting height). Depending on the application of workstation 100 (e.g. as an office desk for computer and paperwork), tabletop 104 may have a raised height 128 of between 0.9 m and 1.5 m for use by a standing user, and a lowered height 132 of between 0.5 m and 0.8 m for use by a seated user. In some cases, vertical actuator 112₁ (FIG. 1) can be stopped at many or every height between the raised and lower heights. This allows workstation 100 to accommodate users of different body heights, and to accommodate different user postures (e.g. an upright posture when typing, or a leaning posture when drawing or handwriting).

Horizontal actuator 112₂ may form part of the connection between tabletop 104 and vertical support 108. For example, horizontal actuator 112₂ may be operable to move tabletop 104 relative to the ground and vertical support 108 in a direction towards or away from a user position. As shown, this allows horizontal actuator 112₂ to move tabletop 104 between a rearward position (FIGS. 2A and 3A) and a forward position (FIGS. 2B and 3B). In the illustrated example, tabletop 104 is mounted to vertical support 108 by a rail assembly 136 (FIG. 1), and horizontal actuator 112₂ is a linear actuator (e.g. motorized leadscrew or rack and pinion) that moves tabletop 104 along the rail assembly 136 between the rearward position (FIGS. 2A and 3A) and the forward position (FIGS. 2B and 3B).

In some embodiments, there may be multiple actuators 112 that operative simultaneously or in succession to move tabletop 104 in one direction (e.g. along a linear, rotary, or curved path). For example, workstation 100 may include two or more spaced apart vertical supports 108 to provide greater stability in the case of a large tabletop 104, each vertical support 108 may include a vertical actuator 112₁ (FIG. 1), and all of the vertical actuators 112₁ (FIG. 1) may be activated simultaneously to move the tabletop 104 between elevations.

Returning to FIG. 1, workstation 100 may include OEM actuator(s) 112 driven by OEM drive controller(s) 116 at the direction of OEM user operable controls 120. The OEM user operable controls 120 send control signals to the OEM drive controller(s) 116, and in response, the OEM drive controller(s) 116 activate the OEM actuator(s) 112 in accordance with the control signals. As used herein, components of workstation 100 may be referred to as “OEM” where that part was included with workstation 100 as a standard or optional feature at the time of purchasing, selling, delivering, or assembling workstation 100. OEM parts may be associated with the same manufacturer or the same seller. For example, a Steelcase™ Series 7 electric height adjustable workstation when purchased and delivered includes an OEM tabletop, OEM vertical support, OEM actuator, OEM drive controller, and OEM user operable controls, all of which were manufactured by or supplied by Steelcase™.

In some instances, a workstation 100 may be equipped with OEM drive controller 116 and user operable controls 120 that provide limited functionality (e.g. limited user customizability, operating modes, and safety features). For example, OEM user operable controls 120 may provide only simple directional buttons 124 that are manually selectable to raise and lower tabletop 104. Further, OEM drive controller 116 may lack safety features, such as the capability to detect and respond to obstructions. Where an obstruction is a user, this can result in user injury. Where an obstruction is an object, this can result in property damage. In either case, a failure to detect and respond to an obstruction can result in damage to workstation 100. For example, if workstation actuator 112 is or includes an electric motor, the electric motor can be burned out if the electric motor continues to be powered while the obstruction prevents tabletop 104 from moving.

In one aspect, workstation controller 140 may provide a replacement for OEM user operable controls 120, and that may interface with the OEM drive controller(s) 116 to augment workstation 100 with enhanced or additional functionality such as safety features that can mitigate user injury and damage to property and the workstation itself. For owners of workstation 100 equipped with only OEM components, an upgrade using workstation controller 140 can avoid the expense of replacing the entire workstation 100 in order to obtain the enhanced features provided by workstation controller 140. For users shopping for a workstation 100, workstation controller 140 allows them the flexibility to select and purchase a workstation 100 on the basis of brand, style, size, and shape, without concern over whether the workstation 100 has the features provided by workstation controller 140, and then to upgrade the workstation 100 with the expanded feature set using workstation controller 140.

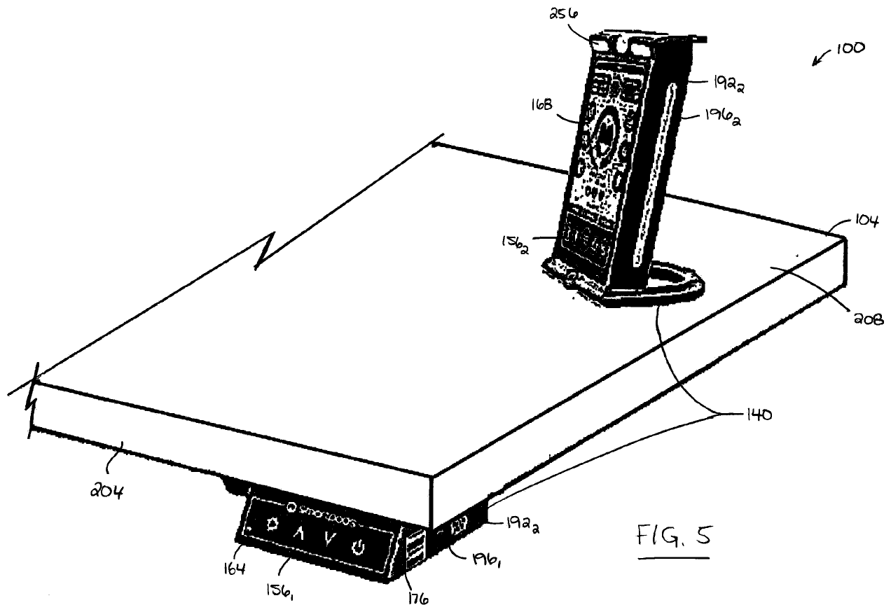

Reference is now made to FIG. 4, which shows a schematic illustration of a workstation drive system 144. Workstation drive system 144 may include one or more OEM drive controllers 116, one or more OEM drive actuators 112, and a workstation controller 140. In the illustrated example, workstation actuation system 144 is shown including two OEM drive controllers 116 each drivingly connected to a respective OEM drive actuator 112. In some cases, an OEM drive controller 116 is provided for each drive actuator 112 (e.g. one OEM drive controller 116 for a vertical actuator 112 and one OEM drive controller 116 for a horizontal actuator 112). In other cases, an OEM drive controller 116 controls several drive actuators 112 (e.g. one OEM drive controller 116 to synchronize several vertical actuators 112, or one OEM drive controller 116 to control both vertical and horizontal actuators 112).

The schematic of FIG. 4 further illustrates the disconnection of OEM user operable controls 120 and replacement with workstation controller 140. This substitution is also illustrated in FIG. 1. User operable controls 120 may have been communicatively coupled to drive controller(s) 116, and manually operable (i.e. operable by deliberate physical interaction with a user's body part, such as a finger) to send command signals to OEM drive controller(s) 116 to activate drive actuators 112. For example, user operable controls 120 may provide an active-low input whereby manual activation of the user operable controls 120 may signal an OEM drive controller 116 by grounding an input pin of the OEM drive controller 116. In response to the low signal, the OEM drive controller 116 may be configured to (e.g. by hardwiring) to power corresponding actuator(s) 112 accordingly (e.g. activate a relay to connect a high voltage power source to the actuator(s) 112 with the correct voltage polarity for the instructed movement direction).

As shown, workstation controller 140 takes the place of OEM user operable controls 120 and introduces hardware and software to workstation 100 (FIG. 1) that enhances workstation 100 (FIG. 1) with new features. In the example shown, workstation controller 140 includes a processor 148, memory 152, user operable controls 156, position sensor 160, presence sensor 164, display 168, power input 172, power output 176, drive power module 180, drive control module 184, and pressure sensors 188. In some embodiments, workstation controller 140 includes multiple of any one or more (or all) of processor 148, memory 152, user operable controls 156, position sensor 160, presence sensor 164, display 168, power input 172, power output 176, drive power module 180, drive control module 184, and pressure sensors 188. In some embodiments, workstation controller 140 does not include one or more of user operable controls 156, position sensor 160, presence sensor 164, display 168, power output 176, drive power module 180, and pressure sensors 188. For example, workstation controller 140 may not include position sensor 160, and/or may not include presence sensor 164, and/or may not include display 168, and/or may not include power output 176, and/or may not include drive power module 180, and/or may not include pressure sensors 188.

Each of memory 152, user operable controls 156, position sensor 160, presence sensor 164, display 168, power input 172, power output 176, drive power module 180, drive control module 184, and pressure sensors 188 may be communicatively coupled to processor 148, directly or indirectly. In some embodiments, workstation controller 148 is a single, unitary device having a housing 192 (FIG. 1) that houses all of its subcomponents (processor 148, memory 152, etc.). In other embodiments, workstation controller 148 is composed of two or more discrete devices that are communicatively coupled to each other, that collectively include all of the subcomponents of workstation controller 148 (processor 148, memory 152, etc.), and that collectively provide the functionality described herein.

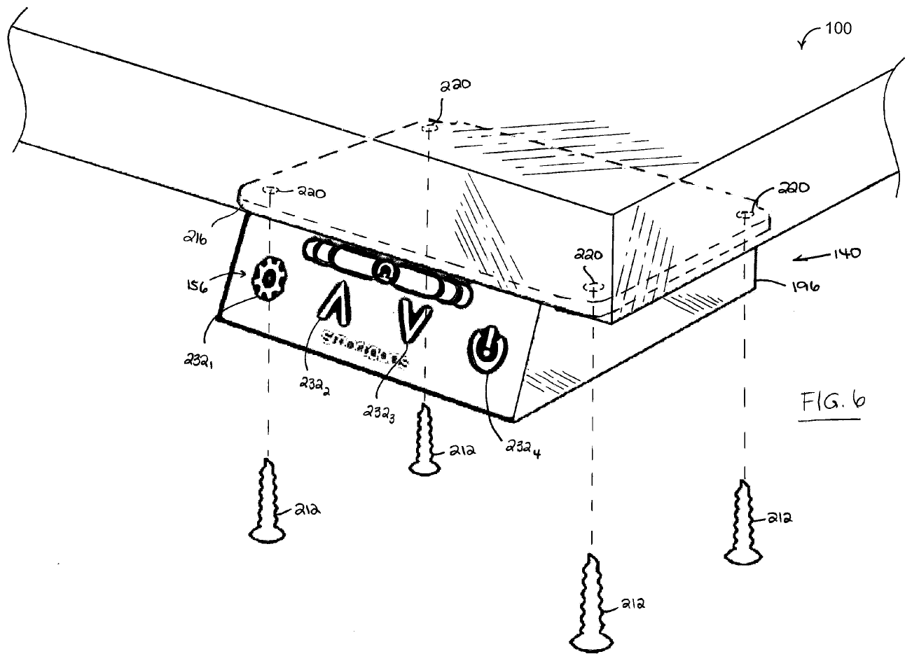

As an example, FIG. 5 shows a workstation controller 140 that includes a first device 196₁ having a first housing 192₁, and a second device 196₂ having a second housing 192₂. In this example, first device 196₁ may include a processor, memory, user operable controls 156₁, presence sensor 164, power input, power output 176, and a drive control module; and second device 196₂ may include another processor, a display 168, user operable controls 156₂, and power input. All other divisions/combinations of subcomponents between several devices 196 are expressly contemplated.

It will be appreciated that by dividing the subcomponents of workstation 100 between discrete devices 196, certain elements of workstation 100 may be better positioned to perform their function. For example, under-mounting first device 196₁ to tabletop 104 proximate tabletop front end 204 may provide convenient access for a user to interact with user operable controls 156₁; and placing an upright second device 196₂ atop tabletop upper surface 208 may provide the user with a convenient view of display 168. This illustrates that some sub-components may perform better when positioned above tabletop 104, whereas others may perform better positioned elsewhere (e.g. below tabletop 104). Other arrangements of discrete devices 196 are expressly contemplated.

Referring to FIG. 6, workstation controller 140 may be connected to workstation 100 in any manner. For example, workstation controller 140 may be connected to workstation 100 by fasteners (e.g. screws, nails, bolts, or rivets), magnets, hook and loop fasteners, adhesive, or tape. In the illustrated embodiment, workstation controller device 196 is connected to workstation 100 by fasteners 212. As shown, workstation controller 140 may include a mount 216 that facilitates the connection to workstation 100 (e.g. to workstation tabletop 104). In the illustrated example, mount 216 includes apertures 220 for fasteners 212.

Alternatively or in addition, at least a portion of workstation controller 140 may not be rigidly connected to workstation 100. For example, FIG. 5 shows workstation controller device 196₂ seated atop tabletop upper surface 208, but not necessarily rigidly connected thereto. This can allow workstation controller device 196₂ to be repositioned, e.g. for best visibility of display 168.

Returning to FIG. 4, memory 152 can include volatile memory (e.g. random access memory (RAM)) or non-volatile storage (e.g. ROM, flash memory, hard disk drive, solid state drive, or other types of non-volatile data storage). In some embodiments, memory 152 stores one or more applications for execution by processor 148. The applications correspond with software modules including computer executable instructions to perform processing for the functions and methods described below. In some embodiments, some or all of memory 152 may be integrated with processor 148. For example, processor 148 may be a microcontroller (e.g. Microchip™ AVR, Microchip™ PIC, or ARM™ microcontroller) with onboard volatile and/or non-volatile memory.

In some embodiments, workstation controller 140 stores information in remote storage device(s), such as cloud storage, accessible across a network. In some embodiments, workstation controller 140 stores data (e.g. software modules, user preferences, data records, etc.) distributed across multiple storage devices, such as memory 152. For example, workstation controller 140 may store some data in the ROM of processor 148, on a connected USB flash drive, and in cloud storage. Each of the multiple storage devices may store a portion of the data of workstation controller 140, and collectively the multiple storage devices may store all of the data of workstation controller 140. Accordingly, as used herein and in the claims (unless expressly stated otherwise), data is said to be “stored in memory” where that data is stored in a local storage device, stored in a remote storage device (e.g. cloud storage), or that data is distributed across multiple storage devices, each of which can be local or remote.

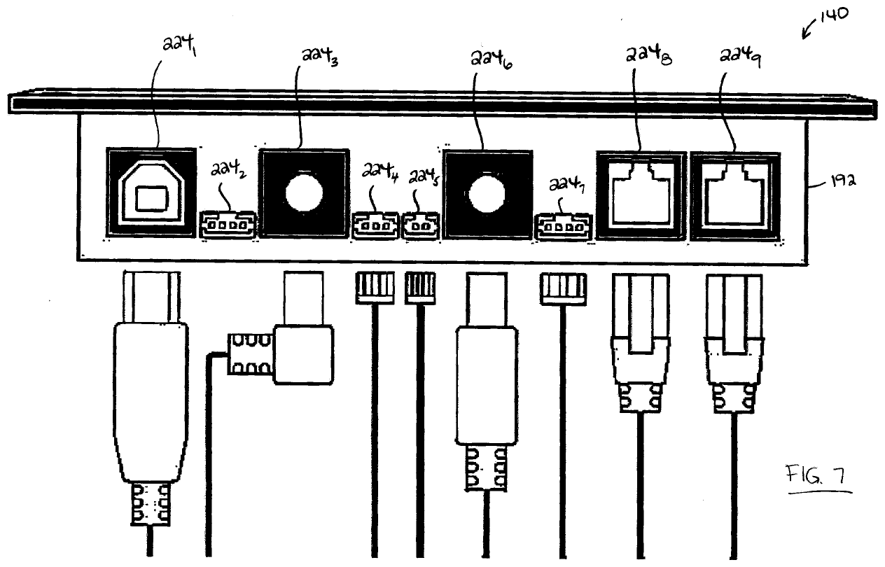

Generally, processor 148 can execute computer readable instructions, which may be referred to as an application or programs. The computer readable instructions can be stored in memory 152 (e.g. stored locally, or stored remotely and accessible through a network connection). When executed, the computer readable instructions are said to “configure” processor 148 (or multiple processors 148, collectively) to perform the acts described herein with reference to workstation controller 140. In some embodiments, processor 148 includes a microcontroller (e.g. e.g. Microchip™ AVR, Microchip™ PIC, or ARM™ microcontroller) with numerous I/O ports that may be communicatively coupled to one or more (or all) of memory 152, user operable controls 156, sensors 160 and 164, display 168, drive modules 180 and 184, and power modules 172 and 176 for example. Processor 148 may communicate with each subcomponent (e.g. memory 152, user operable controls 156, etc.) by wire or wirelessly. As illustrated in FIG. 7, workstation controller 140 may include numerous wired connection ports 224 for communicating (i.e. sending and/or receiving) power and data to and/or from the subcomponents that are external to device housing 192. Within device housing 192, subcomponents may be communicatively coupled to processor 148 (FIG. 4) by cables and/or PCB traces for example.

Returning to FIG. 4, workstation controller 140 includes a drive control module 184. Drive control module 184 may be or include a wired or wireless output port for commands from processor 148 to OEM drive controller(s) 116. This allows drive control module 184 to send commands to OEM drive controller 116 to operate the OEM actuators 112 in accordance with determined actuator movements. In some embodiments, drive control module 184 may include one or more data cable connectors (e.g. RJ45 ports 224₈ and 224₉ in FIG. 7) for making a wired connection between drive control module 184 and OEM drive controller(s) 116. As shown, OEM drive controller 116 may include a control input 228 that is disconnected from OEM user operable controls 120 and connected instead to drive control module 184. Workstation controller 140 may generate signals for output by drive control module 184, which emulate the original output protocol of OEM user operable controls 120 to OEM drive controller 116. This allows drive control module 184 to generate and send signal commands compatible with OEM drive controller 116.

Processor 148 may determine the targeted actuator movements (e.g. to raise or lower tabletop 104 (FIG. 1) by a certain distance or to a certain height, or to home to the default elevation) based at least in part on input from user operable controls 156. User operable controls 156 may be any input device that can be manually operated (i.e. operated by interaction with a user's body part) to make user selections. For example, user operable controls 156 may include one or more of tactile or capacitive buttons 232 (FIG. 6), switches, or sliders; control knobs; or touch screens. User operable controls 156 may be communicatively coupled to processor 148 by wire or wirelessly. When activated by the user, user operable controls 156 may signal processor 148, and in response processor 148 may determine one or more actuator movements, or a regimen of actuator movements and command OEM drive controller 116 accordingly via drive control module 184.

As an example, a user may press an ‘up arrow’ button 232₂ (FIG. 6) on user operable controls 156 to signal processor 148 to raise tabletop 104 (FIG. 1) to standing height. In response, processor 148 may retrieve the standing height from memory 152 and then generate signals to command OEM drive controller 116 to activate a vertical actuator 112 accordingly. Processor 148 may monitor the elevation of the tabletop by reference to position readings from position sensor(s) 160. In response to the processor 148 determining that the standing height has been reached, the processor 148 may generate signals to command OEM drive controller 116 to deactivate the vertical actuator 112. This illustrates an example of workstation controller 140 providing a “one-touch” transition between preset seated and standing heights, whereas the original OEM user operable controls 120 may have provided only “press and hold” manual height adjustments.

### Automatic Movement Regimen

Workstation controller 140 may be configured to provide automatic and/or semi-automatic modes of operation. In some embodiments, an automatic or semi-automatic mode of operation may be user selectable using user operable controls 156. An automatic mode of operation may be associated with an automatic movement regimen stored in memory 152. In response to receiving user input from user operable controls 156 indicative of a selection to operate in an automatic or semi-automatic mode of operation, processor 148 may determine an ordered sequence of actuator movements based at least in part on the automatic movement regimen. For example, the automatic movement regimen may include moving tabletop 104 (FIG. 1) between a seated height and a standing height at a certain interval (e.g. every 10 minutes), and the seated and standing heights for the current user may be stored in a user profile within memory 152. Processor 148 may generate signals to command OEM drive controller(s) 116 to perform the determined actuator movements.

As used herein and in the claims, “determining an ordered sequence of actuator movements based on an automatic movement regimen” may include (i) determining several or all actuator movements prior to first signaling the OEM drive controller, or (ii) determining actuator movements periodically before, during, and/or between commands signaled to the OEM drive controller as, before, or after the OEM drive actuator completes the actuator movements. For example, processor 148 may determine the next in the sequence of actuator movements after commanding the OEM drive controller(s) 116 to perform the previous actuator movement and determining that the previous actuator movement has completed successfully (e.g. the target height for workstation tabletop 104 (FIG. 1) has been reached).

In a fully automatic mode of operation, processor 148 may generate and send signals to OEM drive controller 116 via drive control module 184, to perform the ordered sequence of actuator movements determined from the automatic movement regimen, automatically (i.e. without any requirement for user input or other user interaction). For example, the automatic movement regiment may include moving workstation tabletop 104 between raised and lowered positions in intervals, and in an absence of user input, processor 148 may signal commands to the OEM drive controller(s) 116 to operate the workstation actuators 112 accordingly. An advantage of a fully automatic mode of operation is that it can promote better compliance with an activity schedule (e.g. change of height every X minutes) as compared to relying on the user to manually initiate workstation movements themselves, and it does so with minimal user distraction (e.g. it is performed without prompting the user for confirmation).

When in a semi-automatic mode of operation, processor 148 may wait to receive user input from user operable controls 156 before sending each subsequent command or several commands (e.g. to execute a complex movement) to OEM drive controller(s) 116. For example, the automatic movement regiment may include moving workstation tabletop 104 (FIG. 1) between raised and lowered positions in intervals, and processor 148 waits each time for user confirmation from user operable controls 156 before commanding OEM drive controller(s) 116 to operate OEM actuator(s) 112 to change the height of workstation tabletop 104 (FIG. 1). An advantage of a fully automatic mode of operation is that it can promote better compliance with an activity schedule (e.g. change of height every X minutes) as compared to relying on the user to manually initiate workstation movements themselves, and it does so while mitigating disruption to users' ongoing tasks (e.g. it is performed only with user confirmation). For example, this can avoid moving the workstation tabletop 104 (FIG. 1) while the user is in the middle of handwriting a note.

In various embodiments, workstation controller 140 may provide a semi-automatic mode of operation, an automatic mode of operation, both, or neither.

### Drive Power Sensing

Still referring to FIG. 4, workstation controller 140 may include a drive power module 180. Drive power module 180 may be or include one or more current sensors that obtain a current reading of electrical current flowing from OEM drive controller(s) 116 to drive actuator(s) 112. The current readings from drive power module 180 are communicated to processor 148 by wire or wirelessly. Processor 148 may determine whether the received current readings satisfy criteria associated with obstructive interference stored in memory 152. As used herein and in the claims, “criteria” may include just one criterion or may include many criteria. In response to determining that the criteria is/are satisfied, processor 148 may direct the OEM drive controller(s) 116 to perform actuator movements based on a safety protocol stored in memory 152.

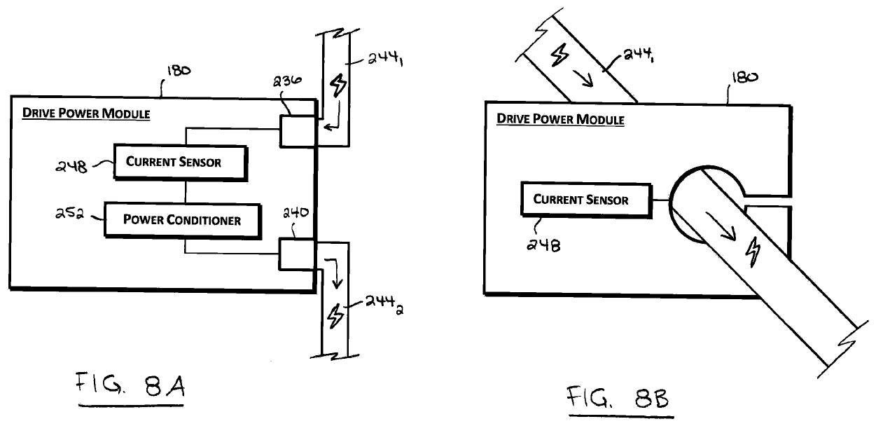

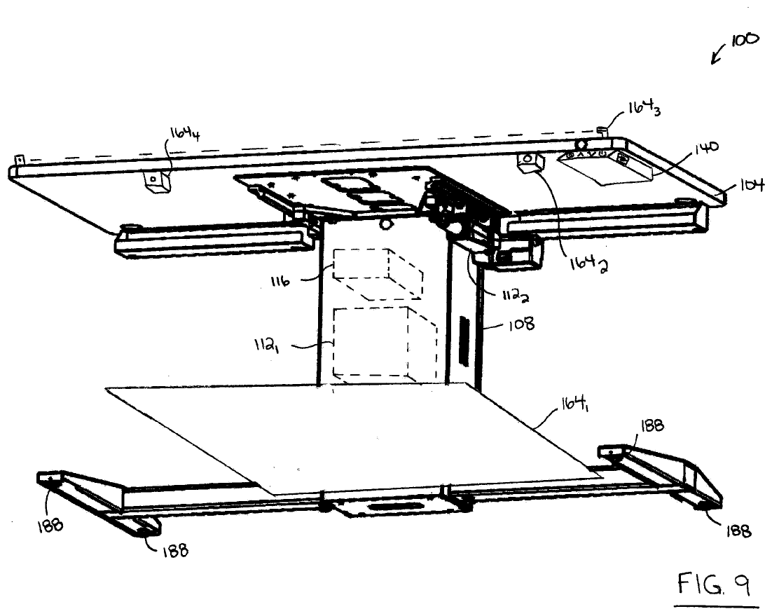

Reference is now made to FIGS. 4 and 8A. As shown, drive power module 180 may include an actuator power input port 236 (e.g. 224₃ in FIG. 7) and an actuator power output port 240 (e.g. 224₆ in FIG. 7). Instead, of OEM drive controller 116 delivering power directly to drive actuator(s) 112, the actuator power cable(s) 244₁ from OEM drive controller power output port 256 may be rerouted to actuator power input port 236, and additional actuator power cable(s) 244₂ may connect actuator power output port 240 to drive actuator(s) 112. This allows drive power module 180 to be electrically positioned in the power transmission line between OEM drive controller 116 and drive actuator(s) 112 so that drive power module 180 may take current readings, condition the electrical power output, or both.

In the illustrated example, drive power module 180 includes a current sensor 248 configured to take current readings from power received from OEM drive controller 116 (FIG. 4) (to power drive actuator(s) 112) at actuator power input port 236. Drive power module 180 may transmit the current readings to processor 148, which may determine whether the current readings satisfy criteria associated with obstructive interference.

When an obstruction interferes with a movement of workstation 100 (FIG. 1) (i.e. “obstructive interference”), an actuator 112 may be inhibited from moving freely. One example of obstructive interference may include, for example a collision between an office chair and workstation tabletop 104 (FIG. 1) that inhibits or resists the lowering of workstation tabletop 104 (FIG. 1). Another example of obstructive interference may include, for example a user sitting on workstation tabletop 104 (FIG. 1) which overburdens the workstation actuators 112 in their attempt to raise workstation tabletop 104 (FIG. 1). During an occurrence of obstructive interference, current delivered from OEM drive controller(s) 116 to drive actuator(s) 112 may increase substantially (e.g. by at least 10%, or at least 25% or more). If the incident is allowed to continue, there can be damage to the actuator(s) 112 (e.g. the motors may burn out), damage to property (e.g. the property causing the obstructive interference), or user injury (e.g. where the user is the cause of the obstructive interference).

Processor 148 may determine whether current readings from current sensor 248 satisfy criteria associated with obstructive interference. The criteria may include a current threshold, which may be an absolute or relative value or change in value. For example, the criteria may include one or more (or all) of:
(i) a threshold current value (e.g. in amperes) associated with a current rating of the associated actuator 112,
(ii) a threshold absolute current increase (e.g. in amperes),
(iii) a threshold relative current increase (e.g. in percentage, such as at least 10% or at least 25%),
(iv) a threshold absolute rate of current increase (e.g. in amperes per time unit), or
(v) a threshold relative rate of current increase (e.g. in percentage per time unit).

In response to determining that the current readings from the current sensor 248 satisfy the criteria associated with obstructive interference, processor 148 may generate and send signals to command the OEM drive controller 116 to operate the associated workstation actuator(s) 112 according to a safety protocol stored in memory 152. The safety protocol may include one or more actuator movements including, for example one or more of:
i) reversing the direction of the actuator 112 (e.g. for a predetermined time, a predetermined distance, or to a predetermined position),
ii) moving the actuator 112 to its home position (e.g. a predetermined default position),
iii) deactivating or braking the actuator 112, or
iv) moving the actuator 112 to a predetermined safety position.

As an alternative to current sensor 248 or in addition to current sensor 248, drive power module 180 may include a power conditioning unit 252. The power conditioning unit 252 may condition the power before it is output to the actuator(s) 112 via actuator power output port 240. For example, power conditioning unit 252 may include one or more of a high-pass filter to remove unwanted low frequency signals/fluctuations, or a low-pass filter to remove unwanted high frequency signals/fluctuations. In some embodiments, power conditioning unit 252 includes a fast blow fuse to quickly cut the power when the current exceeds a first threshold, and/or a slow blow fuse to cut the power when the current exceeds a second threshold for a certain period of time. The current threshold of the slow blow fuse may be lower than the fast blow fuse. The slow blow fuse may allow for momentary current spikes that are typical when certain actuators (e.g. motors) are initiated from a stopped condition.

Referring to FIGS. 4 and 8B, in some embodiments drive power module 180 does not electrically connect OEM drive controller 116 to drive actuator 112. For example, drive power module 180 may include a current sensor 248 that can measure current in actuator power cable 244₁ from outside of actuator power cable 244₁ (e.g. by reference to the magnetic field emitted from power cable 244₁). In this case, drive power module 180 may not include actuator power input or output ports, and actuator power cable 244₁ may remain connected from OEM drive controller power output 256 to drive actuator 112.

Returning to FIG. 4, in some embodiments drive power module(s) 180 sense current for power directed to two or more drive actuator(s) 112. For example, workstation controller 140 may include two or more drive power modules 180 (e.g. two or more of the drive power modules 180 of FIGS. 8A or 8B). This allows workstation controller 140 to sense current and/or condition power delivered to two or more drive actuator(s) 112. In some embodiments, two or more of the drive actuator(s) 112 operate cooperatively to move an element of workstation 100 (e.g. to raise and lower workstation tabletop 104) (FIG. 1). The criteria indicative of obstructive interference may include whether a difference in current being transmitted to the two drive actuators 112 from the OEM drive controller(s) 116 exceeds a predetermined threshold. The threshold may be an absolute value (e.g. in amperes) or a relative value (e.g. in percentage). For example, the criteria may be a relative difference in current of 10% or more (of the lesser current).

### Position Sensing

Referring to FIG. 4, in some embodiments workstation controller 140 may include one or more position sensors 160. As used herein and in the claims, a “position sensor” may refer to any device that can sense any one or more (or all) of a spatial location, elevation, angular orientation, velocity (e.g. angular or linear), or acceleration (e.g. angular or linear) of an associated element (e.g. workstation tabletop 104 (FIG. 1)). Signals (i.e. information) from a position sensor 160 may be referred to as “position readings”. A position sensor 160 may include, for example one or more (or all) of an accelerometer, a gyroscope, a magnetometer, a range finder (e.g. time of flight range finger), a vibration sensor (e.g. piezo vibration sensor), and an inertial measurement unit (IMU). Position sensors 160 may be alternative to or in addition to drive power module 180, for example.

In one aspect, memory 152 may store position criteria associated with obstructive interference. Processor 148 may determine whether position readings from position sensor(s) 160 satisfy the position criteria. In response to determining that the current readings from position sensor(s) 160 satisfy the criteria associated with obstructive interference, processor 148 may generate and send signals to command the OEM drive controller 116 to operate the associated workstation actuator(s) 112 according to a safety protocol stored in memory 152. The safety protocol may include one or more actuator movements as described elsewhere herein.

In some embodiments, the position criteria may include vibration exceeding a threshold vibration. This may provide early detection of a moving element of workstation 100 (e.g. workstation tabletop 104) (FIG. 1) striking a hard object, resulting in clearly detectable vibrations.

Alternatively or in addition, the position criteria may include a movement speed below a threshold movement speed, acceleration below a threshold acceleration, or deceleration above a threshold deceleration. The threshold speed, acceleration, or deceleration may be relative to the expected speed, acceleration, or deceleration of the moving element (e.g. workstation tabletop 104 (FIG. 1)) while being actuated (e.g. an absolute speed or acceleration difference, or a relative speed or acceleration difference in percentage). For example, the threshold speed and acceleration may be 90% or less of the expected speed and acceleration, and the threshold deceleration may be 110% or more of the expected deceleration. Obstruction by a compliant object (e.g. a soft chair) may reduce but not immediately halt the speed of a moving workstation tabletop 104 (FIG. 1), whereas obstruction by a hard object (e.g. metal waste-bin) may sharply reduce or halt the movement of workstation tabletop 104 (FIG. 1).

Alternatively or in addition, the position criteria may include a tilt angle exceeding a threshold tilt angle of the moving element of workstation 100 (e.g. workstation tabletop 104) (FIG. 1). Typically, obstructive interference results in a torque being applied to the moving element, which may cause the moving element to tilt. The threshold tilt angle may be a relative tilt angle (i.e. relative to the unobstructed condition) of a predetermined number of degrees (e.g. at least 5 degrees) or an absolute tilt angle of the moving element (e.g. relative to the ground or gravity).

### Presence Sensing

Still referring to FIG. 4, in some embodiments workstation controller 140 includes one or more presence sensors 164. Presence sensor 164 may be provided in addition to or in an alternative to position sensor(s) 160, and/or drive power module 180. As used herein and in the claims, a presence sensor 164 may be any device that can sense an indication (i.e. a presence reading) that a user is present at workstation 100 (FIG. 1), and communicate that presence reading (by wire or wirelessly) to processor 148. Presence sensor 164 may include, for example one or more (or all) of a pressure pad, a thermal sensor (e.g. infrared camera), a beam break sensor, and an ultrasonic sensor. As an example, FIG. 9 shows an embodiment of workstation 100 including a pressure pad 164₁, a thermal camera 164₂, a beam break sensor 164₃, and an ultrasonic sensor 164₄.

Returning to FIG. 4, memory 152 may store a termination protocol. In response to determining that the presence readings from the presence sensor 164 indicate a user is absent from workstation 100 (FIG. 1), processor 148 may generate and send signals to command the OEM drive controller 116 to operate the associated workstation actuator(s) 112 according to the termination protocol stored in memory 152. The termination protocol may include one or more actuator movements including, for example moving the actuator 112 to its home position (e.g. a predetermined default position), or deactivating or braking the actuator 112. This may prevent workstation 100 (FIG. 1) from continuing to actuate while unattended by a user. For example, this may pause or discontinue an automatic mode of operation pending the return of the user.

### Pressure Sensing

Still referring to FIG. 4, in some embodiments workstation controller 140 may include one or more pressure sensors 188. Pressure sensor 188 may be provided in addition to or in an alternative to position sensor(s) 160, and/or presence sensor(s) 164, and/or drive power module 180. As used herein and in the claims, a pressure sensor 188 may be any device that can sense pressure or force exerted upon an element of workstation 100 (i.e. a ‘pressure reading’) and communicate that pressure reading (by wire or wirelessly) to processor 148. Pressure sensor 188 may include, for example one or more (or all) of piezo-resistive force sensor, a force sensitive resistor, or a pressure transducer. As an example, FIG. 9 shows an embodiment of workstation 100 including pressure sensors 188 under vertical support 108.

Memory 152 may store pressure criteria associated with obstructive interference. Processor 148 may determine whether pressure readings from pressure sensor(s) 184 satisfy the pressure criteria. In response to determining that the pressure readings from the pressure sensor 188 satisfy the pressure criteria associated with obstructive interference, processor 148 may generate and send signals to command the OEM drive controller 116 to operate the associated workstation actuator(s) 112 according to a safety protocol stored in memory 152. The safety protocol may include one or more actuator movements as described elsewhere herein.

The pressure criteria may include a pressure or force value that falls below or exceeds a threshold pressure or force. The threshold pressure or force may be an absolute or relative pressure or force value, or an absolute or relative change in pressure or force value, which may be indicative of obstructive interference. For example, the threshold pressure or force may reflect a maximum pressure or force for which the associated drive actuator(s) 116 are rated, or the threshold pressure or force may reflect a change in pressure or force indicative of interference by an obstacle.

### Other Features

Workstation controller 140 may include a power input 172 to supply power to workstation controller 140 for its operation. Alternatively or in addition, workstation controller 140 may include a power output 176 for supplying power to peripherals. For example, workstation controller 140 may include one or many USB charging ports 176 as shown in FIG. 5. This can allow a user to conveniently charge their peripherals (e.g. smartphones, wireless headphones, etc.) at their workstation 100.

Referring to FIGS. 4 and 5, workstation controller 140 may include a display 168. Display 168 may present information and alerts to the user (e.g.

notification of a detection of obstructive interference), and provide user operable controls 156₂ to make user selections (e.g. to set seated and standing heights, configure automatic movement regimens, confirm semi-automatic movements etc.). In some embodiments, workstation controller 140 may include a task light 256 to illuminate tabletop upper surface 208.

Although the above description references a workstation having many OEM components upgraded by embodiments of a workstation controller 140, in some embodiments workstation controller 140 is an OEM component. For example, workstation controller 140 may be an original component of workstation 100 and not used to upgrade a pre-existing workstation configuration. In some embodiments, workstation controller 140 is provided as an upgrade for pre-existing workstations, and a compatible drive controller is included with workstation controller 140 (i.e. to replace the OEM drive controller of the workstation).

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

### Items

Item 1: A workstation controller for operating at least one drive controller of a power actuated workstation, each drive controller operating at least one workstation actuator, the workstation controller comprising:
one or more processors;
a memory communicatively coupled to at least one of the processors, the memory storing a safety protocol;
a first drive control output communicatively coupled to at least one of the processors;
a first current sensor communicatively coupled to at least one of the processors; and one or more user operable controls, each user operable control communicatively coupled to at least one of the processors,
wherein when the workstation controller is communicatively connected to a first drive controller that operates at least a first workstation actuator, the one or more processors are configured to collectively:
   determine one or more actuator movements for the first workstation actuator based at least in part on user-input received from the one or more user operable controls,
   transmit to the first drive controller, by way of the first drive control output, one or more commands to operate the first workstation actuator to perform the one or more determined actuator movements,
   receive, from the first current sensor, a first current reading of electrical current flowing from the first drive controller to the first workstation actuator, and
   in response to the processor determining that the first current reading exceeds a predetermined current threshold associated with obstructive interference, transmit to the first drive controller, by way of the drive control output, one or more commands to operate the first workstation actuator to perform the safety protocol.
Item 2: The workstation controller of any other item, wherein:
the first drive control output comprises a data cable connection port or a wireless radio.
Item 3: The workstation controller of any other item, further comprising:
a housing configured to be mounted to a workstation tabletop, the housing holding at least the one or more user operable controls.
Item 4: The workstation controller of any other item, wherein:
the one or more user operable controls includes at least one of a button, switch, slider, control knob, or touchscreen.
Item 5: The workstation controller of any other item, wherein:
the safety protocol comprises one or more commands to (i) stop movement of the first workstation actuator, (ii) move the first workstation actuator to a home position, or (iii) reverse a movement direction of the first workstation actuator.
Item 6: The workstation controller of any other item, wherein:
the memory stores an automatic movement regimen;
said determining the one or more actuator movements comprises receiving from the one or more user operable controls, user input indicative of a selection to operate in an automatic mode of operation, and determining a plurality of actuator movements based at least in part on the automatic movement regimen, and
said transmitting the one or more commands to operate the first workstation actuator to perform the one or more determined actuator movements comprises automatically transmitting the one or more commands to perform the plurality of actuator movements in an ordered sequence in an absence of user input.
Item 7: The workstation controller of any other item, wherein:
the memory stores an automatic movement regimen;
said determining the one or more actuator movements comprises receiving from the one or more user operable controls, user input indicative of a selection to operate in a semi-automatic mode of operation, and determining a plurality of actuator movements based at least in part on the automatic movement regimen, and
said transmitting the one or more commands to operate the first workstation actuator to perform the one or more determined actuator movements comprises waiting for user confirmation before transmitting commands to perform each actuator movement of the plurality of actuator movements.
Item 8: The workstation controller of any other item, wherein:
the memory stores position criteria associated with obstructive interference,
the workstation controller further comprises a position sensor communicatively coupled to at least one of the processors, and
when the workstation controller is communicatively connected to the first drive controller, the one or more processors are further configured to collectively:
   receive, from the position sensor, a position reading associated with a workstation tabletop of the power actuated workstation, and
   in response to determining that the position reading satisfies the position criteria, transmit to the first drive controller, by way of the drive control output, one or more commands to operate the first workstation actuator to perform the safety protocol.
Item 9: The workstation controller of any other item, wherein:
the position criteria comprises one or more of a threshold movement speed, a threshold acceleration, or a threshold deceleration.
Item 10: The workstation controller of any other item, wherein:
the position criteria comprises a threshold vibration.
Item 11: The workstation controller of any other item, wherein:
the position reading is indicative of a tilt angle of the workstation tabletop, and
the position criteria comprises a threshold tilt angle.
Item 12: The workstation controller of any other item, wherein:
the position sensor comprises one or more of an accelerometer, a gyroscope, and an inertial measurement unit.
Item 13: The workstation controller of any other item, wherein
the workstation controller comprises one or more current sensors including the first current sensor,
when the workstation controller is communicatively connected to the first drive controller that operates the first workstation actuator and a second workstation actuator, the one or more processors are further configured to collectively:
   receive, from one of the one or more current sensors, a second current reading of electrical current flowing from the first drive controller to the second workstation actuator, and
   in response to the processor determining that a difference between the first and second current readings exceeds a predetermined threshold associated with obstructive interference, transmit to the first drive controller, by way of the drive control output, one or more commands to operate the first and second workstation actuators to perform the safety protocol.
Item 14: The workstation controller of any other item, further comprising:
an actuator power input port that when connected to the first drive controller receives power output by the first drive controller to power the first workstation actuator, and
an actuator power output port that when connected to the first workstation actuator delivers power received at the actuator power input port to the first workstation actuator.
Item 15: The workstation controller of any other item, wherein:
the first current sensor is configured to sense electrical current received at the actuator power input port.
Item 16: The workstation controller of any other item, further comprising:
one or more pressure sensors communicatively coupled to at least one of the processors,
wherein the memory stores pressure criteria associated with obstructive interference, and
when the workstation controller is communicatively connected to the first drive controller, the one or more processors are further configured to collectively:
   receive, from the one or more pressure sensors, one or more pressure readings associated with forces acting on the power actuated workstation, and
   in response to determining that the pressure reading satisfies the pressure criteria, transmit to the first drive controller, by way of the drive control output, one or more commands to operate the first workstation actuator to perform the safety protocol.
Item 17: The workstation controller of any other item, wherein:
the memory stores a termination protocol,
the workstation controller further comprises one or more user-presence sensors communicatively coupled to at least one of the processors, and
when the workstation controller is communicatively connected to the first drive controller, the one or more processors are further configured to collectively:
   receive, from at least one of the one or more user-presence sensors, a presence reading indicating whether a user is present at the power actuated workstation, and
   in response to determining based on the presence reading that the user is absent from the power actuated workstation, transmit to the first drive controller, by way of the drive control output, one or more commands to operate the first workstation actuator to perform the termination protocol.
Item 18: The workstation controller of any other item, wherein:
the termination protocol comprises one or more commands to (i) stop movement of the first workstation actuator, or (ii) move the first workstation actuator to a home position.
Item 19: The workstation controller of any other item, wherein:
the termination protocol comprises one or more commands to pause or cancel automatic movements of the first workstation actuator.
Item 20: The workstation controller of any other item, wherein:
the presence sensor comprises one or more of a motion sensor, a pressure sensor, a beam break sensor, a time of flight sensor, and a thermal sensor.
Item 21: A workstation controller for operating at least one drive controller of a power actuated workstation, each drive controller operating at least one workstation actuator, the workstation controller comprising:
one or more processors;
a memory communicatively coupled to at least one of the processors, the memory storing a safety protocol and position criteria associated with obstructive interference;
a first drive control output communicatively coupled to at least one of the processors;
a position sensor communicatively coupled to at least one of the processors; and
one or more user operable controls, each user operable control communicatively coupled to at least one of the processors,
wherein when the workstation controller is communicatively connected to a first drive controller that operates at least a first workstation actuator, the one or more processors are configured to collectively:
   determine one or more actuator movements for the first workstation actuator based at least in part on user-input received from the one or more user operable controls,
   transmit to the first drive controller, by way of the first drive control output, one or more commands to operate the first workstation actuator to perform the one or more determined actuator movements,
   receive, from the position sensor, a position reading associated with a workstation tabletop of the power actuated workstation, and
   in response to determining that the position reading satisfies the position criteria, transmit to the first drive controller, by way of the drive control output, one or more commands to operate the first workstation actuator to perform the safety protocol.
Item 22: A workstation controller for operating at least one drive controller of a power actuated workstation, each drive controller operating at least one workstation actuator, the workstation controller comprising:
one or more processors;
a memory communicatively coupled to at least one of the processors, the memory storing an automatic movement regimen;
a first drive control output communicatively coupled to at least one of the processors; and
one or more user operable controls, each user operable control communicatively coupled to at least one of the processors,
wherein when the workstation controller is communicatively connected to a first drive controller that operates at least a first workstation actuator, the one or more processors are configured to collectively:
   receive from the one or more user operable controls, user input indicative of a selection to operate in a semi-automatic mode of operation,
   determine a plurality of actuator movements to perform in sequence based at least in part on the automatic movement regimen;
   transmit to the first drive controller, by way of the first drive control output, one or more commands to operate the first workstation actuator to perform the plurality of determined actuator movements,
      wherein before transmitting commands to perform each actuator movement of the plurality of actuator movements, the one or more processors are collectively configured to wait for user confirmation.
Item 23: A method of upgrading a power operated workstation, the method comprising:
disconnecting an OEM user control box from the power operated workstation;
attaching the workstation controller of any other item to the power operated workstation;
communicatively coupling the workstation controller to the first drive controller; and
connecting the first current sensor to a power line that delivers power to the first workstation actuator.
Item 24: The method of any other item, further comprising:
rerouting power, that is delivered from the first drive controller to the first workstation actuator, through the workstation controller for current sensing by the first current sensor.

1. A workstation controller for operating at least one drive controller of a power actuated workstation, each drive controller operating at least one workstation actuator, the workstation controller comprising:
one or more processors;
a memory communicatively coupled to at least one of the processors, the memory storing a safety protocol;
a first drive control output communicatively coupled to at least one of the processors;
a first current sensor communicatively coupled to at least one of the processors; and
one or more user operable controls, each user operable control communicatively coupled to at least one of the processors,
wherein when the workstation controller is communicatively connected to a first drive controller that operates at least a first workstation actuator, the one or more processors are configured to collectively:
determine one or more actuator movements for the first workstation actuator based at least in part on user-input received from the one or more user operable controls,
transmit to the first drive controller, by way of the first drive control output, one or more commands to operate the first workstation actuator to perform the one or more determined actuator movements,
receive, from the first current sensor, a first current reading of electrical current flowing from the first drive controller to the first workstation actuator, and
in response to the processor determining that the first current reading exceeds a predetermined current threshold associated with obstructive interference, transmit to the first drive controller, by way of the drive control output, one or more commands to operate the first workstation actuator to perform the safety protocol.

2. The workstation controller of claim 1, wherein:
the first drive control output comprises a data cable connection port or a wireless radio.

3. The workstation controller of claim 1, further comprising:
a housing configured to be mounted to a workstation tabletop, the housing holding at least the one or more user operable controls.

4. The workstation controller of any one of claim 1, wherein:
the one or more user operable controls includes at least one of a button, switch, slider, control knob, or touchscreen.

5. The workstation controller of claim 1, wherein:
the safety protocol comprises one or more commands to (i) stop movement of the first workstation actuator, (ii) move the first workstation actuator to a home position, or (iii) reverse a movement direction of the first workstation actuator.

6. The workstation controller of any one of claim 1, wherein:
the memory stores an automatic movement regimen;
said determining the one or more actuator movements comprises receiving from the one or more user operable controls, user input indicative of a selection to operate in an automatic mode of operation, and determining a plurality of actuator movements based at least in part on the automatic movement regimen, and
said transmitting the one or more commands to operate the first workstation actuator to perform the one or more determined actuator movements comprises automatically transmitting the one or more commands to perform the plurality of actuator movements in an ordered sequence in an absence of user input.

7. The workstation controller of claim 1, wherein:
the memory stores an automatic movement regimen;
said determining the one or more actuator movements comprises receiving from the one or more user operable controls, user input indicative of a selection to operate in a semi-automatic mode of operation, and determining a plurality of actuator movements based at least in part on the automatic movement regimen, and
said transmitting the one or more commands to operate the first workstation actuator to perform the one or more determined actuator movements comprises waiting for user confirmation before transmitting commands to perform each actuator movement of the plurality of actuator movements.

8. The workstation controller of claim 1, wherein:
the memory stores position criteria associated with obstructive interference,
the workstation controller further comprises a position sensor communicatively coupled to at least one of the processors, and
when the workstation controller is communicatively connected to the first drive controller, the one or more processors are further configured to collectively:
receive, from the position sensor, a position reading associated with a workstation tabletop of the power actuated workstation, and
in response to determining that the position reading satisfies the position criteria, transmit to the first drive controller, by way of the drive control output, one or more commands to operate the first workstation actuator to perform the safety protocol.

9. The workstation controller of claim 8, wherein:
the position criteria comprises one or more of a threshold movement speed, a threshold acceleration, or a threshold deceleration.

10. The workstation controller of claim 8, wherein:
the position criteria comprises a threshold vibration.

11. The workstation controller of claim 8, wherein:
the position reading is indicative of a tilt angle of the workstation tabletop, and
the position criteria comprises a threshold tilt angle.

12. The workstation controller of claim 8, wherein:
the position sensor comprises one or more of an accelerometer, a gyroscope, and an inertial measurement unit.

13. The workstation controller of claim 1, wherein
the workstation controller comprises one or more current sensors including the first current sensor,
when the workstation controller is communicatively connected to the first drive controller that operates the first workstation actuator and a second workstation actuator, the one or more processors are further configured to collectively:
receive, from one of the one or more current sensors, a second current reading of electrical current flowing from the first drive controller to the second workstation actuator, and
in response to the processor determining that a difference between the first and second current readings exceeds a predetermined threshold associated with obstructive interference, transmit to the first drive controller, by way of the drive control output, one or more commands to operate the first and second workstation actuators to perform the safety protocol.

14. The workstation controller of claim 1, further comprising:
an actuator power input port that when connected to the first drive controller receives power output by the first drive controller to power the first workstation actuator, and
an actuator power output port that when connected to the first workstation actuator delivers power received at the actuator power input port to the first workstation actuator.

15. The workstation controller of claim 14, wherein:
the first current sensor is configured to sense electrical current received at the actuator power input port.

16. The workstation controller of claim 1, further comprising:
one or more pressure sensors communicatively coupled to at least one of the processors,
wherein the memory stores pressure criteria associated with obstructive interference, and
when the workstation controller is communicatively connected to the first drive controller, the one or more processors are further configured to collectively:
receive, from the one or more pressure sensors, one or more pressure readings associated with forces acting on the power actuated workstation, and
in response to determining that the pressure reading satisfies the pressure criteria, transmit to the first drive controller, by way of the drive control output, one or more commands to operate the first workstation actuator to perform the safety protocol.

17. The workstation controller of claim 1, wherein:
the memory stores a termination protocol,
the workstation controller further comprises one or more user-presence sensors communicatively coupled to at least one of the processors, and
when the workstation controller is communicatively connected to the first drive controller, the one or more processors are further configured to collectively:
receive, from at least one of the one or more user-presence sensors, a presence reading indicating whether a user is present at the power actuated workstation, and
in response to determining based on the presence reading that the user is absent from the power actuated workstation, transmit to the first drive controller, by way of the drive control output, one or more commands to operate the first workstation actuator to perform the termination protocol.

18. The workstation controller of claim 17, wherein:
the termination protocol comprises one or more commands to (i) stop movement of the first workstation actuator, or (ii) move the first workstation actuator to a home position.

19. The workstation controller of claim 17, wherein:
the termination protocol comprises one or more commands to pause or cancel automatic movements of the first workstation actuator.

20. The workstation controller of claim 17, wherein:
the presence sensor comprises one or more of a motion sensor, a pressure sensor, a beam break sensor, a time of flight sensor, and a thermal sensor.

21. A workstation controller for operating at least one drive controller of a power actuated workstation, each drive controller operating at least one workstation actuator, the workstation controller comprising:
one or more processors;
a memory communicatively coupled to at least one of the processors, the memory storing a safety protocol and position criteria associated with obstructive interference;
a first drive control output communicatively coupled to at least one of the processors;
a position sensor communicatively coupled to at least one of the processors; and
one or more user operable controls, each user operable control communicatively coupled to at least one of the processors,
wherein when the workstation controller is communicatively connected to a first drive controller that operates at least a first workstation actuator, the one or more processors are configured to collectively:
determine one or more actuator movements for the first workstation actuator based at least in part on user-input received from the one or more user operable controls,
transmit to the first drive controller, by way of the first drive control output, one or more commands to operate the first workstation actuator to perform the one or more determined actuator movements,
receive, from the position sensor, a position reading associated with a workstation tabletop of the power actuated workstation, and
in response to determining that the position reading satisfies the position criteria, transmit to the first drive controller, by way of the drive control output, one or more commands to operate the first workstation actuator to perform the safety protocol.

22. A workstation controller for operating at least one drive controller of a power actuated workstation, each drive controller operating at least one workstation actuator, the workstation controller comprising:
one or more processors;
a memory communicatively coupled to at least one of the processors, the memory storing an automatic movement regimen;
a first drive control output communicatively coupled to at least one of the processors; and
one or more user operable controls, each user operable control communicatively coupled to at least one of the processors,
wherein when the workstation controller is communicatively connected to a first drive controller that operates at least a first workstation actuator, the one or more processors are configured to collectively:
receive from the one or more user operable controls, user input indicative of a selection to operate in a semi-automatic mode of operation,
determine a plurality of actuator movements to perform in sequence based at least in part on the automatic movement regimen;
transmit to the first drive controller, by way of the first drive control output, one or more commands to operate the first workstation actuator to perform the plurality of determined actuator movements,
wherein before transmitting commands to perform each actuator movement of the plurality of actuator movements, the one or more processors are collectively configured to wait for user confirmation.

23. A method of upgrading a power operated workstation, the method comprising:
disconnecting an OEM user control box from the power operated workstation;
attaching the workstation controller of claim 1 to the power operated workstation;
communicatively coupling the workstation controller to the first drive controller; and
connecting the first current sensor to a power line that delivers power to the first workstation actuator.

24. The method of claim 23, further comprising:
rerouting power, that is delivered from the first drive controller to the first workstation actuator, through the workstation controller for current sensing by the first current sensor.
